(19) United States
(12) Patent Application Publication
(10) Pub. No.: US 2007/0144065 A1
(43) Pub. Date: Jun. 28, 2007

(54) Irrigation mat and plant seeding mat system

(76) Inventor: Jerry B. Lowe, San Clemente, CA (US)

Correspondence Address: Roger C. Turner, Suite 306, 280 Cagney Ln., Newport Beach, CA, 92663, US

(21) Appl. No.: 11/318,816

(22) Filed: Dec. 27, 2005

(51) Int. Cl. A01G 25/00

(52) U.S. Cl. 47/21.1

(57) ABSTRACT

An irrigation and seeding mat includes a plurality of flexible drip tubes, arranged longitudinally along the length of the mat and laterally spaced apart along the width of the mat, with each drip tube having a series of openings therein for dripping water from the tube. The mat has a first biodegradable sheet attached to the drip tubes. The biodegradable sheet extends over the length and width of the mat for initially securing the longitudinal and laterally spaced apart arrangement of the drip tubes. The mat further includes: a layer of plant seeds arranged on the upper surface of the first biodegradable sheet; and has a second biodegradable sheet attached onto the first biodegradable sheet for initially securing the layer of arranged seeds within the mat. The mat is deployed with a manifold having outlet nipples connected to each of the drip tubes.

### BACKGROUND OF THE INVENTION

The invention relates to an agricultural irrigation system and a plant seeding system; particularly to an irrigation and plant seeding mat that can be manufactured, then transported and deployed at a desired ground location.

The invention more particularly relates to an expedient means for establishing an initial lawn system, a ground cover system, a vegetable garden, or a flower garden, and then provides a continuing irrigation drip system for the plants. The system can be provided in small mat sizes for home lawn and garden use, or provided in very large scale sizes for use in commercial planting and irrigating applications.

In the past, plants and crops were irrigated with spray or sprinkler systems and with flooding systems that were inefficient due to significant run-off and evaporation of water that did not benefit the plants. In order to achieve efficient irrigation, a number of “trickier”, “soaker” and “dripper” systems were developed. These systems commonly involve controlled application of water to the root zone of the plants without significant direct exposure to air and sun, and with minimum evaporation.

The drip method typically involves the use of sub surface tubes and hoses that are porous or have leaky seams to provide a gradual dripping of water for the plants, as described in U.S. Pat. No. 3,381,359 to Chapin entitled Soil Soaking system. This patent to Chapin describes a system using a header with lateral tubes to provide a soaking system. Other examples of such systems are described in U.S. Pat. No. 3,672,571 to Goodricke entitled Trickle Irrigation System; U.S. Pat. No. 3,426,544 to Curtis entitled Aqua-Tube SubSurface Irrigation; and U.S. Pat. No. 4,928,427 to Patterson entitled Irrigation System.

The foregoing examples of prior art have their particular advantages, but typically require that the various pipes and components must be delivered to the proposed crop site, then further fabricated and assembled at this location. These systems are quite labor intensive to layout and assemble, and require a significant amount of time and expense to install.

Improvements have been made to irrigation tubing as described in U.S. Pat. No. 3,774,850 to Zeman entitled Water Distribution Tube. This patent to Zeman describes a pair of flat thermoplastic strips manufactured into water distribution tubes, and further describes various orifices and capillary openings for the gradual dispensing of water from the tubes. The separated tubes are laid in rows of large agricultural fields and are not utilized in mats. The tubes further relate to biodegradable tubes for a single crop season, which are plowed up at the end of the season.

An attempt at a manufactured irrigation system is described in U.S. Pat. No. 4,065,926 to Brandt entitled Subterranean Irrigation System. This patent discloses a pair of plastic sheets that are sealed along the edges and also sealed internally into squares providing a grid of longitudinal passages that are all interconnected by lateral passages; and the centers of each square is removed and discarded. The grid has one edge passage that is connected to a water storage tank, and the passages of the grid system include perforations to allow water to drip from the passages. Some shortcomings of this system include that the grid system is limited in width to the width of the plastic sheets, the pattern of the passage spacing is fixed and not variable without extensive tooling changes. Further, the complex grid pattern seems to have numerous edges and corners that are difficult to manufacture and with many opportunities for “unwanted” leaks in production, handling and in use. The removal of the centers of each grid square produces a lot of wasted, scrap material and the system seems to be quite expensive to produce. This subterranean system naturally requires that the plastic sheets be buried under the ground of the crop, and then the crop is planted over the buried system.

The irrigation systems of the prior art seem to be separate, distinct and disconnected from the planting of the seeds and the crops themselves; and require another labor intensive process to distribute the seeds for initiating the plants of the crops. The prior art does not suggest combining a manufactured irrigation system with a manufactured seeding mat.

There have been efforts to manufacture the planting and growing material as described in U.S. Pat. No. 4,283,880 to Fjeldsa entitled Peat Paper and Method for its Manufacture; incorporated herein by reference. This patent to Fjeldsa describes several layers producing a flexible peat paper to improve the quality of the soil in connection with planting, sowing or weed-control. This patent further describes that a controlled amounts of seeds and similar additives can be incorporated into the layered composition.

An example of manufactured sod is described in U.S. Pat. No. 5,490,351 to Molnar et al, entitled Low Cost Sod Mat and Method for Propagation. This patent to Molnar et al, describes a reinforcement-non-woven fabric, a layer of planting medium, and having viable plants growing in the medium. The sod may be sold in rolls or rectangular mats.

Another example of an effort to manufacture the planting and growing material is described in U.S. Pat. No. 5,860,245 to Welch entitled Vegetable Growing Mat; and is incorporated herein by reference. This patent to Welch describes a laminated mat including layers of biodegradable base fabric and a plurality of seeds adhered in the base fabric, along with some other additives and a cover fabric to form a flexible mat.

The various manufactured sod, peat paper and vegetable mat systems of the prior art are separate, distinct and disconnected from a related manufactured irrigation system. The manufactured planting and growing materials require that the mat be placed onto a previously installed subterranean irrigation system, or utilize a subsequent sprinkler irrigation system. The prior art does not suggest combining a manufactured seeding mat with a manufactured irrigation system.

It would be advantageous to readily roll out a mat onto a desired ground location that includes an initial seeding for a crop and an integral irrigation system that would initially water the seeds, and continue as an irrigation system for the crop. Such a combined system would require minimal preparation of the ground location prior to positioning the mat, and minimal ground preparation after the mat is positioned to produce the crop.

It is an object of the present invention to provide an irrigation mat system that can be efficiently and inexpensively manufactured, and readily delivered and deployed at a desired ground location.

It is another object to provide a combination irrigation and plant seeding mat system that can be efficiently and inexpensively manufactured and be readily delivered and deployed at a desired ground location.

### SUMMARY OF THE INVENTION

The foregoing objects are accomplished by an improved irrigation and seeding mat of the present invention that is manufactured at a desired location for deployment at a desired remote ground location. The mat is used with a water distribution manifold that is further connected to a regulated water supply.

The mat includes a plurality of flexible drip tubes, arranged longitudinally along the length of the mat, and laterally spaced apart along the width of the mat, with each drip tube having a series of openings therein for dripping water from the tube. The lengths and lateral spacing of the drip tubes can be arranged in a variety of desired configurations depending upon the application of the mat. The mats can be arranged having about 12 tubes extending about 20-40 feet, and laterally spaced apart about 1 foot for a typical lawn and garden application; and can also be arranged having about 40 tubes (or more) extending hundreds of feet, and laterally spaced apart about 2-4 feet for agricultural applications.

The mat preferably has a first thin flexible biodegradable sheet attached to the drip tubes. The sheet extends over the length and width of the mat for initially securing the longitudinally and laterally spaced apart arrangement of the drip tubes. The sheet is flexible and the mat can be arranged more narrowly if desired, and can be rolled into a compact bundle. However, the sheet initially has good tensile strength and can be pulled into its full, flat configuration to position the drip tubes on the ground. The sheet can alternatively be a poly film that acts as a weed barrier when the irrigation mat is deployed; whereby the sheet is selectively penetrated for planting crops, and the sheet remains as a weed barrier.

The foregoing mat can be deployed, with a water manifold and a water supply, as an irrigation mat; or it can be further processed also into an irrigation and plant seeding mat.

An irrigation and plant seeding mat comprises the features of the foregoing irrigation mat and further includes: a layer of plant seeds arranged on the upper surface of the first biodegradable sheet. The mat includes a second flexible sheet attached onto the first biodegradable sheet for initially securing the layer of arranged seeds within the mat. The seeds can alternatively be provided in biodegradable seed packets arranged on the first biodegradable sheet. The selected layer of seeds can be applied and arranged as required for the desired crop, and can further include plant enhancing additives such as powdered peat, fertilizer or pesticides.

The mat is for use with a lateral manifold extending the width of the mat and having a plurality of outlet nipples extending therefrom. The outlet nipples are spaced apart corresponding to the lateral spacing of the drip tubes and are each connected with one of the drip tubes.

A method of manufacturing the irrigation and seeding mat of the present invention includes the steps of:

advancing a lower roll of thermoplastic sheet and a superimposed upper roll of thermoplastic sheet longitudinally and continuously along a work station;

slicing the advancing rolls of thermoplastic sheets longitudinally into a plurality of discrete sheets, each having a desired width and mating side edges;

bonding the mating edges of the plurality of thermoplastic sheets together along the lengths thereof, forming a plurality of discrete flat drip tubes;

forming leak openings along the lengths of the drip tubes;

arranging the plurality of drip tubes into a laterally spaced apart and parallel tube arrangement;

applying a layer of adhesive longitudinally along the surfaces of the plurality of drip tubes;

attaching an advancing first biodegradable sheet onto the adhesive layer,

bonding the first biodegradable sheet to the surfaces of the tubes, thereby forming an irrigation mat; and further,

providing plant seeds arranged on the upper surface of the first biodegradable sheet;

attaching an advancing second flexible sheet to the first biodegradable sheet thereby securing the seeds within the mat;

feeding the advancing end of the mat into a rotating mandrel forming the completed mat into a compact rolled bundle; and

cutting the trailing end of the mat at a desired length, and sealing the ends of the drip tubes of the mats, to complete the process.

The irrigation mat and the irrigation and seeding mat of the present invention reduce the number of components required for irrigation systems. The mats accelerate the process for planting new crops and are particularly adaptable for use in underdeveloped countries.

### BRIEF DESCRIPTION OF THE DRAWINGS

While the novel features of the invention are set forth in the appended claims, the invention will be better understood along with other features thereof from the following detailed description taken in conjunction with the drawings, in which:

FIG. 1 is a front perspective view (partially exploded) of the irrigation mat of the present invention;

FIG. 2 is a top plan view of the mat shown in FIG. 1;

FIG. 3 is a side elevational view of the mat shown in FIG. 2;

FIG. 4 is a sectional view taken along 4-4 of FIG. 2;

FIG. 5 is a sectional view taken along 5-5 of FIG. 2;

FIG. 6 is a front perspective view (partially exploded) of the irrigation and seeding (lawn) mat of the present invention;

FIG. 7 is a front perspective view (partially exploded) of the irrigation and seeding (crop) mat of the present invention;

FIG. 8 is a side elevational view of a method of manufacturing the mat of the present invention;

FIG. 9 is a top plan view, corresponding to method shown in FIG. 8.

### DETAILED DESCRIPTION OF THE INVENTION

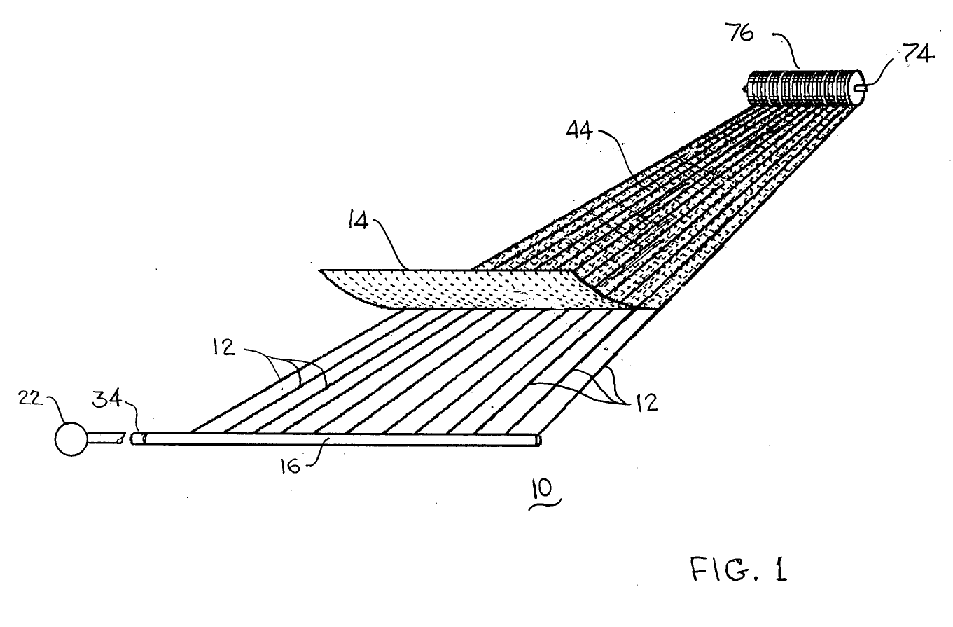

Referring first to FIGS. 1-3, there is illustrated a typical irrigation mat 10 of the present invention. The mat includes a plurality of flexible drip tubes 12 arranged longitudinally along the length of the mat and laterally spaced apart along the width of the mat. A thin flexible sheet 14 is attached to the surfaces of the drip tubes and extends generally over the entire length and width of the mat. (The flexible sheet is shown partially peeled back to show the drip tubes.) The sheet establishes the general dimensions of the mat, and initially secures the longitudinal and laterally spaced apart arrangement of the drip tubes within the mat. The flexible sheet is preferably a biodegradable material; however, the sheet can alternatively be a poly film that acts as a weed barrier when the irrigation mat is deployed, whereby the sheet is selectively penetrated for planting crops. The flexible sheet is shown attached to the upper surface of the drip tubes, but can readily be attached to the lower surfaces as desired.

The irrigation mat 10 utilizes a lateral manifold 16 having a plurality of outlet nipples 18 extending longitudinally and corresponding to the lateral spacing of the drip tubes 12. Each of the nipples is interconnected to the respective drip tube of the mat. The tubes can be secured onto the nipples by a suitable retainer 20. The manifold is further adapted for connection to a regulated, low-pressure water supply 22 when deployed, to complete the mat irrigation system.

Referring also to FIGS. 4 and 5, the flexible drip tubes 12 are formed by an upper thermoplastic sheet 24 superimposed on a lower thermoplastic sheet 26. The sheets are slit longitudinally into a plurality of superimposed strips, about one or two inches wide, and the ends and side edges 28 are sealed together by a typical heat seal, ultra sonic weld or adhesive bonding process. The bonded sheets provide flexible tubes having an internal water passage that can range from flat (see FIG. 4), to oval, to round (see FIG. 5). Each tube includes a series of drip openings 30 that can be provided by lateral slits as shown that extend from the internal passage through the sealed edges to provide suitable paths for dripping water from the tubes. The drip openings can also be provided by apertures or perforations in the surfaces of the tubes, or by unsealed edge portions of the tubes.

As an example of a suitable drip tube 12, the upper and lower sheets are slit into widths of about 1.25 inches, with bonded ends and edges of about 0.12 inches on each side, providing a flat internal passage about one inch wide. The flexible flat tubes have a corresponding peripheral dimension (circumference) of about 2 inches, and can be opened to a circular cross section of about 0.63 inch in diameter.

The size and configuration of the mat 10 can be produced in a variety of specific lengths and widths for specific applications. The lengths of the drip tubes can range from about 20 to 40 feet for home lawn and garden applications; and up to hundreds of feet for agricultural crop applications. The lateral spacing of the tubes within the mat can also range from about 1 to 2 feet apart for irrigating lawns and home gardens, having a total width of about 12 feet for easy handling and deployment by a consumer. For commercial irrigation, the lateral spacing of the tubes within the mat can range from about 2 to 4 feet between rows of agricultural crops and can have an overall width of about 30 to 40 feet in such agricultural applications.

Further in the example of the drip tubes, the leak openings 30 are shown as slits through the sides of the tubes, and can also be formed along with the trimming process of sealing the edges. The leak openings can be provided evenly (at about every 6× the tube diameter) and staggered equally on opposite side of the tubes. The opening can optionally be arranged with the size and spacing of the openings in proportion to the distance from the manifold, to provide good distribution of the water throughout the length of the drip tubes.

The biodegradable sheet 14 is generally formed of organic materials such as paper and non-woven fabric. A suitable biodegradable sheet can be formed of poly-lactic-acid fiber. The sheet is flexible and has good initial tensile strength and integrity, but quickly (within a few weeks) degrades and decomposes when deployed on the ground and exposed to moisture and the environment. This sheet can further be comprised of peat paper and other advantageous materials currently available. The length of the biodegradable sheet is typically continuous, forming the length of the mat. The width of the biodegradable sheet can be continuous, forming the width of the mat; but can conveniently be provided by bonding overlapping widths of the sheets together, when necessary, to cover large width and large area applications of the mat.

As previously described, the tubes are arranged longitudinally and laterally spaced in the desired positions. A narrow application of adhesive is applied to the upper surface 24 of each tube 12. The biodegradable sheet 14 is attached to the upper surface of the tubes. In certain other applications, it may be advantageous to attach the biodegradable sheet to the lower surface of the tubes.

The basic irrigation mat 10 of the present invention comprises the set of drip tubes 12 and the biodegradable sheet 14 attached to the tubes. The flat sheet and flat drip tubes are quite flexible in their extended flat orientation, but can be readily rolled into a compact lateral roll that is quite rigid and stable to handle. The roll is further enclosed within a plastic bag (not shown) to protect the biodegradable sheet from premature exposure to moisture, for a long shelf life. The mats can be readily manufactured into such compact lateral rolls for delivery to a dealer for sale to a consumer. The irrigation mat 10 can be produced and marketed as a separate product; and can be marketed in combination with the manifold 16.

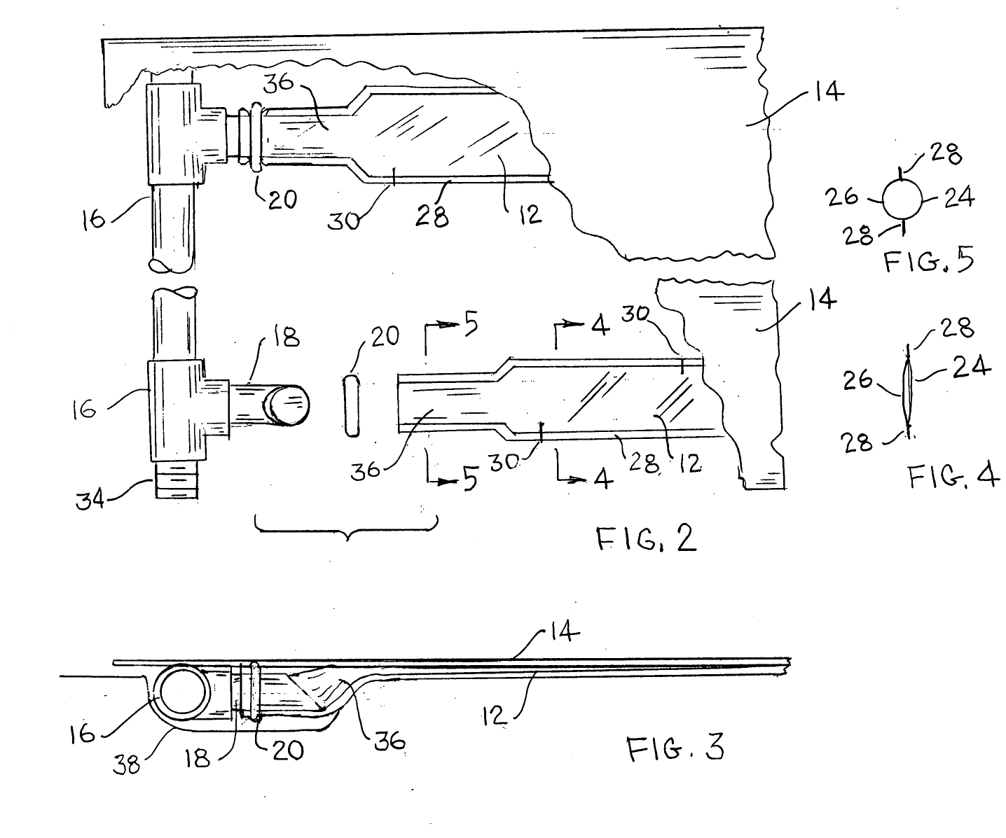

The lateral manifold 16 can be molded into a flexible conduit with spaced outlet nipples for the various configurations of the mat. Another example (see particularly FIGS. 2 and 3), the manifold can be fabricated from standard PVC (poly-vinyl-chloride) tubing and “T” and “L” fittings. As in the example of the mat, the manifold can be fabricated from 0.62 inch diameter tubing and fittings, having outlet nipples extending longitudinally about 3 inches and beveled at about a 45 degree angle. The lateral spacing of the nipples correspond with the lateral spacing of the drip tubes 12 of the specific mat 10. Each nipple can further include (not shown) an annular flange or a series of tapered inclined annular ridges to facilitate insertion and for securing the nipples within the respective drip tube. The manifold includes a suitable fitting 34 at one end for connecting the manifold to the regulated water supply 22.

To connect the manifold 16 to the mat 10, the adjacent ends 36 of the drip tubes 12 are separated about 6 inches from the biodegradable sheet 14, and the sealed ends of the tubes are snipped off. The outlet nipples 18 are inserted into the open ends of the respective drip tubes and the drip tubes are suitably retained on the manifold. The dimensions of the outlet nipples and the drip tubes are sized for a snug fit, and can be further secured with the suitable retainer 20.

To deploy the irrigation mat 10 and the manifold 16, they are delivered to the site, the mat is rolled out onto the desired irrigation location, the mat is connected to the manifold, and the manifold is connected to the water supply 22. The mat can be deployed onto an existing lawn or crop with no ground preparation. The mat can also be deployed on bare soil with minimal preparation.

For areas that are not yet planted, it is preferable, to cultivate the soil to destroy existing weeds and to loosen the soil to promote absorption of the irrigation water and promote root growth of the proposed crop. It may also be helpful to add a layer of soil or root supporting material on the upper surface of the mat to further facilitate root growth and to further retain the position of the tubes.

The manifold can lay on the ground surface; but preferably is placed in a shallow trench 38 (see FIG. 3) to retain the manifold and provide a level surface for the mat. The outlet nipples 18 of the manifold can be oriented to either longitudinal direction for connection to the drip tubes 12, depending on the terrain and the location of the water supply. The drip tubes are initially retained in position by the biodegradable sheet. Soon after the mat is deployed and in use, the biodegradable sheet degrades and separates from the tubes, and the tubes are thereafter retained in position by the ground and related vegetation network of the crop.

The irrigation mat 10 can be further utilized as a simple seeding mat (40) by the addition of a layer of seeds 44 arranged onto the biodegradable sheet 14. A layer of water soluble adhesive is applied to the biodegradable sheet (or to the seeds) to adhere the arrangement of the seeds on the surface of the sheet. This simple irrigation and seeding mat is particularly useful to establish ground cover to control soil erosion.

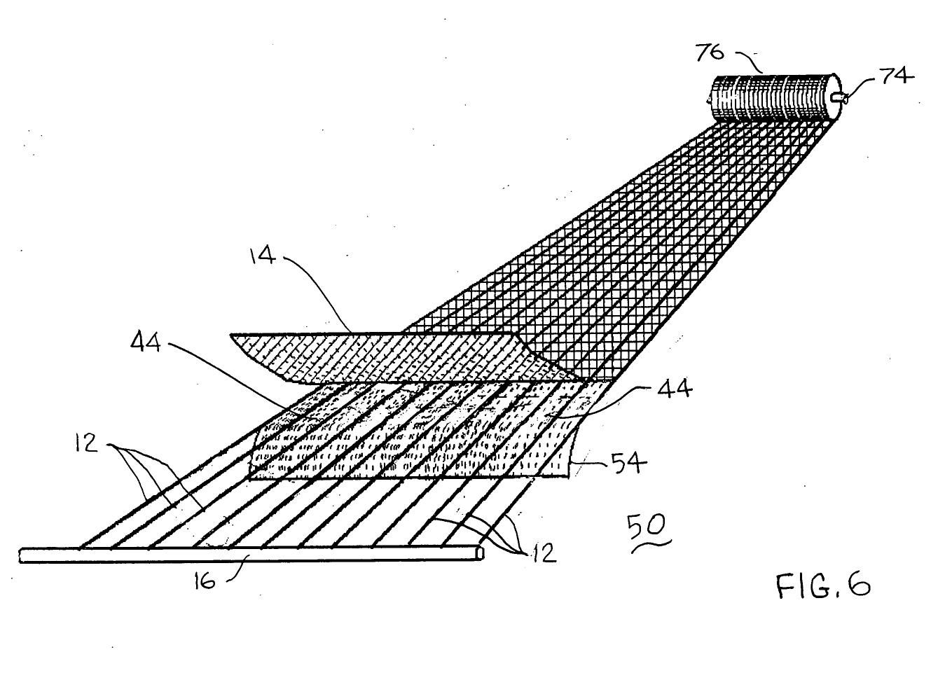

Referring particularly to FIG. 6, there is shown an irrigation and seeding mat 50 of the present invention. This irrigation and seeding mat includes the same drip tubes 12, the (first) biodegradable sheet 14, and the manifold 16 with outlet nipples 18, as previously discussed in reference to irrigating mat 10. The mat further includes a layer of plant seeds 52 arranged on the upper surface of the first biodegradable sheet. The seeds are further secured in position by a second biodegradable sheet 54 superimposed and attached to the first biodegradable sheet. (The first and second biodegradable sheets are shown partially peeled away to better illustrate the drip tubes and the layer of seeds.) The second sheet secures and protects the seeds during production, handling and deployment of the mat.

In more detail, the first biodegradable sheet 14 preferably includes a uniform pattern of undulations and recesses that naturally separates and confines the layer of seeds 52 on the surface of the sheet. An optional intervening biodegradable sheet (not shown) having a grid of openings or cavities may be combined with the sheet 14 to further separate and confine the seeds in the desired arrangement on the first biodegradable sheet. An optional layer of water soluble adhesive may be applied to the first biodegradable sheet (or to the seeds) to adhere the arrangement of the seeds onto the surface of the sheet. The seeds are deposited on the first biodegradable sheet and suitably secured in a desired quantity and spacing arrangement. The second biodegradable sheet 54 is then attached to the first sheet, thereby sealing and confining the seeds within the mat.

The irrigation and seeding mat 50 is deployed with the manifold 16 as previously described in reference to the deployment of the irrigation mat 10. After the mat 50 is deployed on the ground and exposed to moisture and the environment, the biodegradable sheets soon degrade and merge with the soil leaving the layer of seeds to root downward through the sheet 14 and sprout upward through the sheet 64 to initiate the crop.

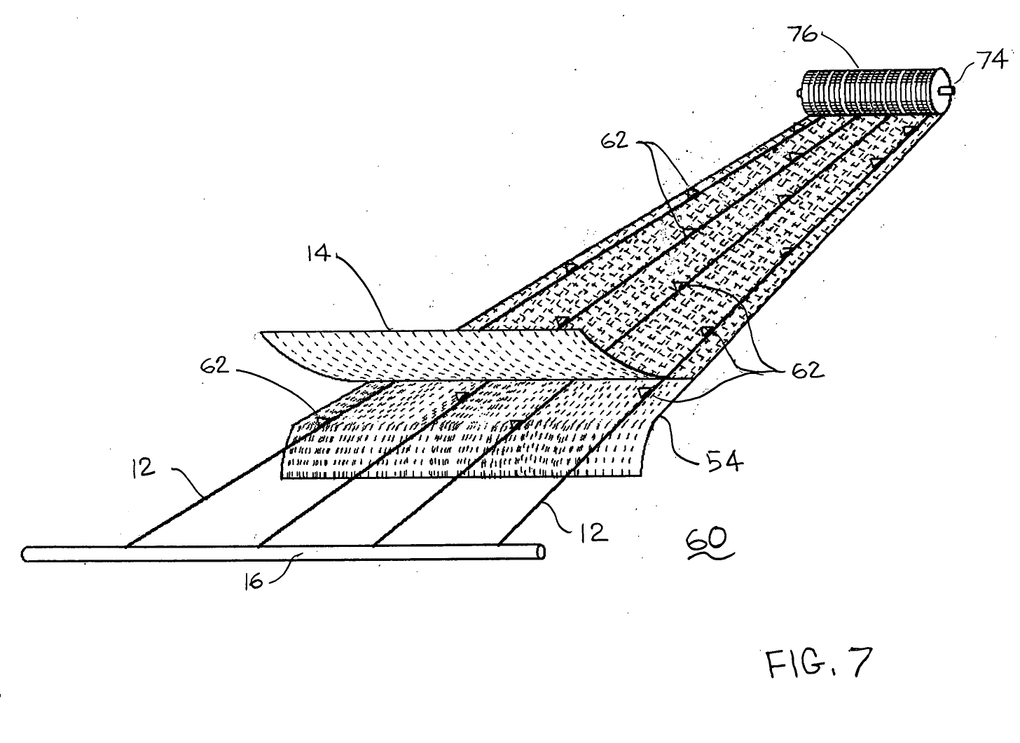

Referring particularly to FIG. 7, there is shown an irrigation and seeding mat 60 of the present invention. This irrigation and seeding mat includes the same drip tubes 12, the first biodegradable sheet 14, and the manifold 16 with outlet nipples 18, as previously discussed in reference to irrigating mat 10. The mat further includes a plurality of seed packets 62 arranged on the upper surface of the first biodegradable sheet. The seed packets are further secured in position by a second biodegradable sheet 54 superimposed and attached to the first biodegradable sheet. (The first and second biodegradable sheets are shown partially peeled away to better illustrate the drip tubes and the seed packets.) The second sheet secures and protects the seed packets during production, handling and deployment of the mat.

The seed packets 62 include a desired quantity of seeds (usually about 5-10) enclosed within a folded biodegradable enclosure. A layer of water soluble adhesive is applied to the seed packets (or to the first biodegradable sheet) to adhere the arrangement of the seed packets onto the surface of the sheet. The seed packets are preferably each arranged close to a drip tube 12 and adjacent a drip opening 30 to insure that each seed packet is readily hydrated. The second biodegradable sheet 54 is then attached to the first sheet, thereby sealing and confining the seed packets within the mat. This mat is particularly useful to establish a vegetable crop.

As a further alternative to the irrigation and seeding (crop) mat 60, the second sheet can be a non-biodegradable sheet to act as a weed barrier when the mat is deployed. The second sheets includes a plurality of “X” type slits over each seed packet, so that the seeds can sprout through the second sheet, while the rest of the second sheet remains to suppress any weeds from growing within the area of the mat.

The drip tubes of the mat can be fabricated separately and assembled with the biodegradable sheets and the layer of seeds, one mat at a time; or preferably the mats are manufactured in an efficient continuous process, as discussed below.

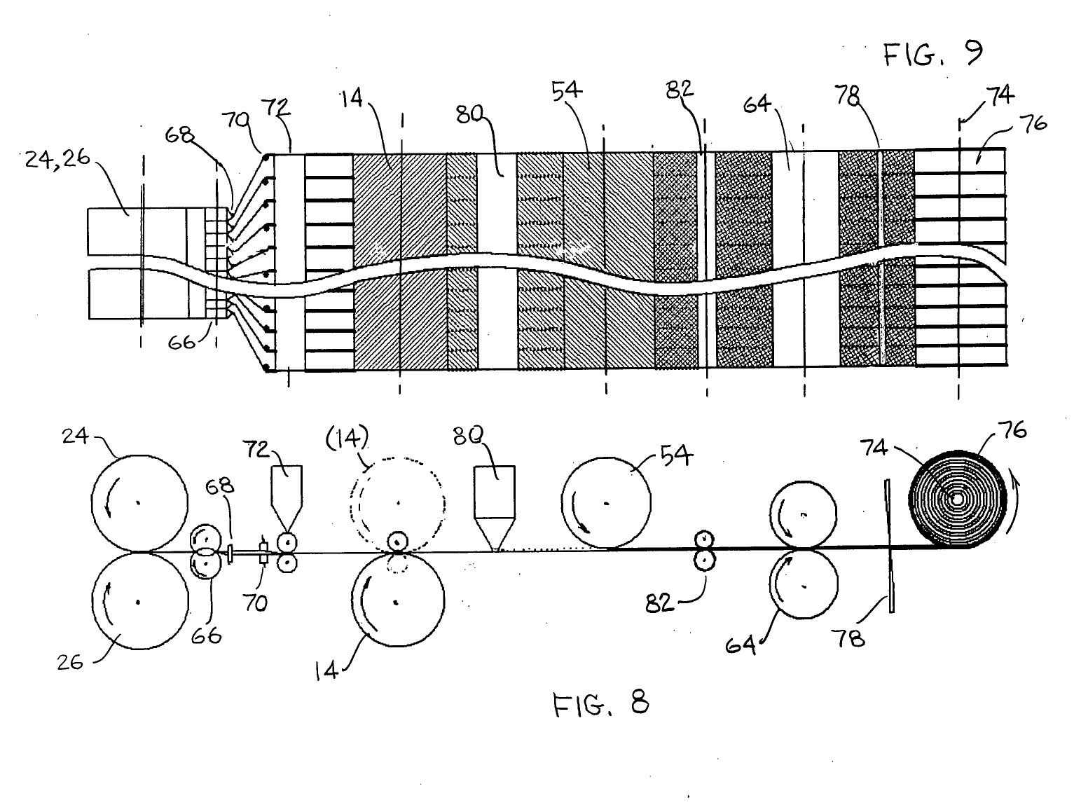

Referring also to FIGS. 8 and 9, the methods of manufacturing the mats will be briefly described. The basic method of manufacturing the irrigation mat 10 is shown with a continuous material flow path from left to right.

A first step in the process includes, advancing a lower roll of the thermoplastic sheet 26 and a superimposed upper roll of the thermoplastic sheet 24 simultaneously and longitudinally along a work station by a pair of opposed pulling rollers 64. The rolls of thermoplastic sheet can suitably range from about 2 feet in width (to provide about 24 one-inch sheets for a home garden mat about 12 feet wide) to about 12 feet in width (to provide about 72 two-inch sheets for larger agricultural mats) or more.

The next steps include, slicing the rolls and bonding the sliced edges, and includes a cutting and edge bonding device 66 suitably including overlapping-disc cutters for slicing the advancing rolls longitudinally into the plurality of discrete thermoplastic sheets, and includes sets of bonding elements at the sides of the rolls and adjacently on each side of the cutters to seal the mating edges of each of the sliced sheets, forming the plurality of discrete flat drip tubes. A variety of cutters, hot wires, ultrasonic welders, and/or heating elements can be designed to perform the steps of the slicing the rolls into narrow sheets and bonding the sheets into drip tubes.

Another step that is suitably combined in the cutting and bonding device 66 is, forming the series of leak openings 30 along the lengths of the drip tubes. A suitable opening can be performed by a lateral cut (or by a non-bonded portion) that makes a small opening through the bonded edge of each drip tube. The series of openings can be arranged to the size and spacing as desired.

Another step is arranging the plurality of drip tubes into a laterally spaced apart and parallel arrangement advancing along the work station. A suitable arranging device includes a first set of rollers 68 having small annular discs separating the tubes, and a second set of roller 70 having small cylinders spaced apart providing openings for directing the tubes into the laterally spaced apart arrangement, and advancing in parallel thereafter. Alternatively, this step can be suitably performed by recessed radiating slots for guiding the drip tubes into the desired laterally spaced apart arrangement.

Another step is, applying a narrow layer of adhesive longitudinally along the lower surfaces of the drip tubes (or alternatively to the upper surface if desired for a biodegradable sheet on the upper surface of the drip tubes) for bonding a sheet onto the tubes. A suitable adhesive is one that is water soluble and biodegradable, and a suitable adhesive applying device 72 includes an adhesive reservoir having a series of rollers in contact with the reservoir and with each of the advancing drip tubes.

The next step, is attaching an advancing first flexible biodegradable sheet 14 onto the layer of adhesive, thereby securing the laterally spaced apart arrangement of the drip tubes.

This generally completes the manufacturing of an advancing irrigation mat 10. The work station further includes a step of feeding the advancing end of the mat onto a rotating mandrel 74, forming a compact rolled mat bundle 76. The mandrels may be arranged in a type of vertical carousel positioning a new mandrel to receive the next mat, as the completed bundle is removed.

The final stage in the process is cutting the mat into the desired lengths. The cutting process includes a lateral shearing and sealing device 78 located between the pulling rollers 64 and the mandrel 74, that shears the trailing end of the completed mat (the biodegradable sheets and drip tubes) and seals the trailing ends of the drip tubes of the mat; and simultaneously also seals the advancing ends of the drip tubes of the next mat.

The rolled bundle of mat is then removed (from the mandrel or with a removable mandrel) and enclosed within a moisture resistant bag for further disposition to inventory or shipping. A new mandrel 74 is automatically positioned to receive the advancing end of the next mat, and the continuous process is repeated for the next mat.

A method of manufacturing the irrigation and seeding mat 50 includes all of the steps as previously discussed in reference to manufacturing the irrigation mat 10, plus the following intervening steps:

Following the step of, attaching the first biodegradable sheet 14 (to the irrigation mat 10), the irrigation and seeding mat 50 includes the step of providing a layer of plant seeds 52 on the upper surface of the first biodegradable sheet. This step is suitably provided by a seeding device 80 having an upper reservoir of seed and a programmable lower opening, or otherwise selectable distributor, at the base for applying the desired layer of seeds onto the sheet. The quantity and the arrangement of the layer of seeds will naturally be determined by the type of crop to be produced by the mat. The layer of seeds can also include other crop enhancing material, such as powdered peat, fertilizer, pesticide etc.

Alternatively, for irrigation and seeding mat 60, the foregoing step can include the deposition of seed packets (rather than the layer of seeds) by the seeding device 80, arranging the packets on the upper surface of the first biodegradable sheet 14.

The next step is, preferably attaching an advancing second flexible biodegradable sheet 54 onto the first biodegradable sheet 14, thereby securing the layer of seeds (or packet of seeds) within the mat. The attaching device 82 is shown as a pair of opposed rollers which suitably perform a mechanical inter-engagement of the sheets, or can suitably include fasteners or the use of biodegradable adhesives to attach the sheets.

As a variation to the mat 60, the second sheet can be a non-biodegradable sheet that includes “X” slits over each seed packet, and when deployed, the sheet remains to provide a weed barrier for the crop. Otherwise, the second non-biodegradable sheet is processed as above.

The irrigation and seeding mat 60 is rotated on the mandrel 74 into a compact rolled bundle, then cut to length, and bagged as previously discussed.

The present invention provides an irrigation mat system that can be efficiently and inexpensively manufactured, and readily delivered and deployed at a desired ground location. The present invention further provides a combination irrigation and plant seeding mat system that can be efficiently and inexpensively manufactured and be readily delivered and deployed at a desired ground location.

While specific embodiments and examples of the present invention have been illustrated and described herein, it is realized that modifications and changes will occur to those skilled in the art. It is therefore to be understood that the appended claims are intended to cover all such modifications and changes as fall within the spirit and scope of the invention.

1. A generally rectangular irrigation mat that is manufactured for deployment at a desired ground location and for connection to a water supply, comprising:
a plurality of flexible drip tubes, having an upper thermoplastic sheet and a lower thermoplastic sheet with their sides and ends sealed together, and arranged longitudinally along the length of the mat, and laterally spaced apart along the width of the mat; and having a series of openings therein for dripping water therefrom; and
a first flexible sheet attached to said tubes, and extending over the length and width of the mat for initially securing the longitudinally and laterally spaced apart arrangement of said tubes; and
wherein the mat is for use with a lateral manifold extending the width of the mat and having a plurality of outlet nipples, spaced apart and extending longitudinally therefrom, and the outlet nipples are each connectable with one of said tubes.

2. The irrigation mat as described in claim 1 wherein said first flexible sheet is a non-biodegradable plastic material, whereby the sheets can be penetrated for implanting crop, and the remaining sheet provides a weed barrier for the crop.

3. The irrigation mat as described in claim 1 wherein said first flexible sheet is a biodegradable material.

4. The irrigation mat as described in claim 1 wherein said flexible drip tubes have a width ranging from about one-half inch to one inch and a length ranging from about twenty to forty feet.

5. The irrigation mat as described in claim 1 wherein said flexible drip tubes have a width ranging from about one to two inches and a length ranging from about fifty feet to about three hundred feet.

6. The irrigation mat as described in claim 1 further comprising a lateral manifold extending the width of the mat and having a plurality of outlet nipples, spaced apart and extending longitudinally therefrom, wherein each of said outlet nipples is connected with one of said tubes, with said manifold further adapted for connection to the water supply.

7. The irrigation mat as described in claim 1 wherein said first sheet is attached to the upper thermoplastic sheet of said tubes.

8. The irrigation mat as described in claim 1 wherein said first sheet is attached to the lower thermoplastic sheet of said tubes.

9. The irrigation mat as described in claim 3 further including a seeding mat comprising: a layer of plant seeds arranged on and secured to the upper surface of said first biodegradable sheet.

10. The irrigation mat as described in claim 3 further including a seeding mat comprising:
a layer of plant seeds arranged on the upper surface of said first biodegradable sheet;
a second flexible biodegradable sheet attached onto said first biodegradable sheet for securing said layer of arranged seeds within the mat.

11. The irrigation mat as described in claim 3 further including a seeding mat comprising:
a plurality of plant seed packets arranged on the upper surface of said first biodegradable sheet;
a second flexible biodegradable sheet attached onto said first biodegradable sheet for securing said layer of arranged seeds within the mat.

12. The irrigation mat as described in claim 3 further including a seeding mat comprising:
a plurality of plant seed packets arranged on the upper surface of said first biodegradable sheet;
a second flexible non-biodegradable sheet attached onto said first biodegradable sheet having openings adjacent said packets for securing said packets within the mat, and the openings allowing the plants to sprout therethrough, and the second sheet providing a weed barrier.

13. The irrigation and seeding mat as in claim 10 further comprising a lateral manifold extending the width of the mat and having a plurality of outlet nipples, spaced apart and extending longitudinally therefrom, and wherein each of said outlet nipples is connected with one of said tubes, with said manifold further adapted for connection to the water supply.

14. The irrigation and seeding mat as in claim 11 further comprising a lateral manifold extending the width of the mat and having a plurality of outlet nipples, spaced apart and extending longitudinally therefrom, and wherein each of said outlet nipples is connected with one of said tubes, with said manifold further adapted for connection to the water supply.

15. A method of manufacturing a generally rectangular irrigation mat for deployment at any desired ground location, for connection to a lateral manifold, and for further connection to a water supply, comprising the steps:
advancing a lower roll of thermoplastic sheet and a superimposed upper roll of thermoplastic sheet longitudinally and continuously along a work station;
slicing the advancing rolls of thermoplastic sheets longitudinally into a plurality of discrete upper thermoplastic sheets and lower thermoplastic sheets, each having a desired width and mating side edges;
bonding the mating edges of the plurality of thermoplastic sheets together along the lengths thereof, forming a plurality of discrete flat drip tubes;
forming leak openings along the lengths of the drip tubes;
arranging the plurality of drip tubes into a laterally spaced apart and parallel tube arrangement;
applying a layer of adhesive longitudinally along the surfaces of the plurality of drip tubes;
attaching an advancing first biodegradable sheet onto the adhesive layer, bonding the first biodegradable sheet to the surfaces of the tubes, thereby forming an irrigation mat;
feeding the advancing end of the mat into a rotating mandrel forming the completed mat into a compact rolled bundle.
cutting the trailing end of the mat at a desired length, and sealing the ends of the drip tubes of the mats.

16. The method of manufacturing the irrigation mat as in claim 11, further including a seeding mat comprising the additional steps:
providing a layer of plant seeds arranged on the upper surface of the first biodegradable sheet;
attaching an advancing second biodegradable sheet to the first biodegradable sheet thereby securing the layer of seeds within the mat.

17. The method of manufacturing the irrigation mat as in claim 11, further including a seeding mat comprising the additional steps:
providing a plurality of plant seed packets arranged on the upper surface of the first biodegradable sheet;
attaching an advancing second biodegradable sheet to the first biodegradable sheet thereby securing the layer of seeds within the mat.

18. The method of manufacturing the irrigation mat as in claim 11, further including a seeding mat comprising the additional steps:
providing a plurality of plant seed packets arranged on the upper surface of the first biodegradable sheet;
attaching an advancing second non-biodegradable sheet to the first biodegradable sheet, wherein the second sheet has slotted openings adjacent the seed packets.
